(19) United States
(12) Patent Application Publication
(10) Pub. No.: US 2012/0279373 A1
(43) Pub. Date: Nov. 8, 2012

(54) APPARATUS HAVING NEGATIVE DOT PATTERN USED IN MACHINING THIN LIGHT GUIDE PLATE

(75) Inventor: BONG GU HEO, DAEGU (KR)

(73) Assignee: IST KOREA CO., LTD., DAEGU (KR)

(21) Appl. No.: 13/193,823

(22) Filed: Jul. 29, 2011

(30) Foreign Application Priority Data
May 4, 2011 (KR) 10-2011-0042503

(51) Int. Cl. B26F 1/08

(52) U.S. Cl. 83/884

(57) ABSTRACT

An apparatus having a negative dot pattern used in machining a light guide plate. The apparatus includes a machining table unit disposed under the light guide plate, a drive unit disposed over the machining table unit, a plurality of adjustment units disposed over the light guide plate, a plurality of machining support units disposed over the light guide plate, and a plurality of machining units disposed over the light guide plate. When each machining unit has reached a machining position by being transported in transverse and vertical directions above the light guide plate by the drive device, each machining unit engraves dots while the light guide plate is being carried in the machining direction. After the light guide plate is machined, the drive device is transported to an upper position and to a position where next dots are intended to be engraved, and the next dots are sequentially engraved.

### CROSS-REFERENCE TO RELATED APPLICATION

This application claims the benefit of Korean Patent Application No. 10-2011-004250356 filed on May 4, 2011, in the Korean Patent and Trademark Office, the disclosures of which are incorporated herein in their entirety by reference.

### BACKGROUND OF THE INVENTION

1. Field of the Invention

The present invention relates to an apparatus having a negative pattern used in machining a thin light guide plate.

2. Description of the Related Art

Generally, display devices are devices that present images based on image signals. Among display devices, a type of display device such as Liquid Crystal Display (LCD) has a color panel that outputs red, green and blue (RGB) colors. Since the color panel does not generate light, a backlight unit for radiating light onto the color panel is provided in order to display an image.

A backlight unit of the related art includes a light source for generating light in order to radiate light onto a display device and a light-refracting means for uniformly supplying light to a flat panel by refracting the light. The backlight unit also includes a light guide plate that has a refracting pattern in order to refract the light that is radiated from the light source. In addition, it has a light-adjusting means for dispersing the light that is refracted by the light guide plate and adjusting the brightness of the light.

The pattern in the light guide plate is machined using a screen printing technique, a molding technique, a polishing roll transfer technique, a laser machining technique, or the like.

Here, the screen printing technique is a stable machining technique that forms a pattern using dots obtained by spraying ink. However, there are problems in that an Ultraviolet (UV) process is required after printing, and that reliability is low and defect ratio is high since the dots are produced respectively. In addition, since V like grooves are not formed, the yield of the screen printing technique is lower than the molding technique.

The molding technique is a technique that directly injects a light guide plate by pouring forming resin, such as Polymethylmethacrylate (PMMA), into a mold, curing the forming resin, and fabricating a shape having a light-scattering function. Although this technique is adequate for mass production, there are problems in that many defects occur due to the thermal deformation of the light guide plate and the cost and period necessary for designing the mold increase.

The polishing roll transfer technique is a technique that fabricates a dispersing plate by forming a pattern on one side of a plate and implanting a dispersing material such as a functional resin into the other side of the of plate. Although this technique can increase flatness and uniformity, there are problems in that it is impossible to stop an extruder even if impurities are attached to the surface of a roll, that defect ratio is difficult to decrease since it is difficult to realize a constant thickness, and that productivity is poor.

In addition, the laser machining technique is a technique that forms grooves by radiating laser beams onto a material that is intended to form a light guide plate. This technique exhibits excellent machining speed and quality compared to traditional techniques. However, this technique has problems in that a laser radiating device is expensive and machining cost increases since a great amount of energy is used in the machining.

Accordingly, there is a technique that scratches linear engraved grooves in a panel-shaped material that is intended to form a light guide plate using a scraper having a plurality of teeth while moving the teeth along predetermined pitch intervals on the panel-shaped material. The technique is widely used since it can decrease defect ratio while reducing machining cost.

Such light guide plates have linear grooves engraved therein that are machined to have different intervals depending on the position of light sources in order to increase the brightness and uniformity of light. That is, the intervals of the grooves are decreased as the distance to the light sources is decreased such that weak light is refracted by the grooves having smaller intervals. This consequently can increase the overall brightness and uniformity of light.

However, if the light guide plate is a thin plate having minimal thickness, there is a problem in that machining the thin light guide plate using a scraper having a plurality of teeth may cause a defect since warping occurs at the positions of the teeth

In addition, the thin light guide plate that is not machined has concave and convex portions on the surface thereof Therefore, if this light guide plate is machined by the existing scraper technique, different heights in the concave and convex portions lead to different machining depths in the concave and convex portions. Furthermore, if an uneven portion of the thin plate is protruded, this portion may be cut during engraving, thereby leading to a defect.

In addition, there are problems in that, since the machining is performed using a plurality of teeth at one time, uneven portions may occur due to the machining, the uneven portions may have different machined depths, or the uneven portions may be cut when an impact resulting from the machining is transmitted to the thin light guide plate at one time.

### SUMMARY OF THE INVENTION

Accordingly, the present invention has been made keeping in mind the above problems occurring in the related art, and the present invention is intended to propose an apparatus having a negative dot pattern used in machining a thin light guide plate that is designed to machine a thin light guide plate, which refracts light that is radiated from a light source, in vertical and transverse directions depending on the angle and height of concave and convex portions in the surface of the light guide plate while minimizing a deformation in the machining of the thin light guide plate, thereby improving machining quality, decreasing defect ratio, and thus improving productivity.

In an embodiment of the present invention, there is provided an apparatus having a negative dot pattern used in machining a thin light guide plate in order to engrave a dot pattern that refracts incident light in the light guide plate. The apparatus includes a machining table unit disposed under the light guide plate, in which the machining table unit is movable in a machining direction when the light guide plate is being machined in a state in which the light guide plate is seated on the machining table unit; a drive unit disposed over the machining table unit, in which the drive unit includes a drive device for providing power to move in a transverse direction in which the dot pattern is intended to be formed in an upper surface of the light guide plate and in a vertical direction and a plurality of drive supports spaced apart from each other at predetermined intervals in the transverse direction of the light guide plate, the drive supports being movable in the transverse direction and the vertical direction in response to an operation of the drive device; a plurality of adjustment units disposed over the light guide plate, in which each of the adjustment units is supported on a respective one of the drive supports, which are separated from each other, such that the respective adjustment unit is movable in the vertical direction; a plurality of machining support units disposed over the light guide plate, in which each of the machining support units is hinged to a respective lower portion of the adjustment units such that the each machining support unit pivots in the transverse direction of the light guide plate; and a plurality of machining units disposed over the light guide plate, in which each of the machining units is rotatably disposed on a respective lower portion of the drive supports, and has teeth on an outer circumference thereof, in which the teeth are configured to machine the light guide plate. When each of the machining units has reached a machining position by being transported in the transverse direction and the vertical direction from a position above the light guide plate by the drive device, each of the machining unit may engrave dots while the light guide plate is being carried in the machining direction. After the light guide plate is machined, the drive device may be transported to an upper position and then in the transverse direction to a position where next dots are intended to be engraved, and the next dots, which are arrayed in the transverse direction, are sequentially engraved the light guide plate is being carried.

The machining table unit may include a machining table disposed under the light guide plate, in which an upper portion of the machining table supports the light guide plate when the dots are engraved in the light guide plate; an absorption fixing device disposed inside the machining table, in which the absorption fixing device fixes the machining table, thereby preventing the machining table from moving, when the light guide plate is being machined; and a machining carriage disposed under the machining table. The machining carriage may transport the machining table to which the light guide plate is fixed via absorption. The light guide plate may be intended to be machined by the machining units while being carried in the machining direction following an operation of the machining carriage, in a state in which the light guide plate is seated on an upper surface of the machining table and is fixed to the machining table by the absorption fixing device.

The drive units may include a drive body disposed on one side of the drive device, in which the drive body is positioned above the light guide plate such that the drive body moves in the transverse direction, and has a shape of a plate that is transported in the vertical and transverse directions depending on the machining position following the operation of the drive device; a drive support disposed on one side of the drive body that is movable, in which a plurality of the drive supports are spaced apart from each other at predetermined intervals, in which the drive support has a closed upper portion, an inner support space, in which the adjustment unit is positioned, and a support hole perforated to open a portion of the support space; and a supporting elastic member disposed inside the drive support to provide elastic force inside the support space. A plurality of the drive supports may be spaced apart from each other at the predetermined intervals that are set restrict a deformation in machining depending on depths to which the engraved dots are machined in the thin light guide plate, and independently machine the engraved dots, and the adjustment unit is disposed in the support space such that the adjustment unit is supported by the supporting elastic member, so that height adjustment is performed when the adjustment unit returns to an original position after being transported in the vertical direction inside the drive support.

Each of the adjustment units may include an adjusting head disposed inside the drive support, in which an upper portion of the adjusting head is elastically supported by the supporting elastic member and a lower portion of the adjusting head is restrained to the support space so that the adjusting head is movable in the vertical direction without being released from the support space; an adjusting shaft protruding from the lower portion of the adjusting head, in which the adjusting shaft extends downwards through the support hole from inside the support space; an adjusting bracket disposed under the drive support, in which an upper portion of the adjusting bracket is fixed to the adjusting shaft such that the adjusting bracket is movable along with the adjusting head, and in which the adjusting bracket has therein an adjusting space, a lower portion of the adjusting space being open; and a hinge shaft disposed inside the adjusting bracket, in which the hinge shaft is disposed in a position of the support space that extends along the machining direction of the light guide plate and is hinged to the machining support unit, such that the machining support unit is allowed to pivot in the transverse direction. The adjusting bracket may be connected via the adjusting shaft to the adjusting head, which is elastically connected to the drive support such that the adjusting head is vertically movable inside the drive support. A plurality of drive supports may be provided per unit. The hinge shaft may be hinged inside the adjusting bracket such that the adjustment unit is movable in the transverse direction. Consequently, the adjusting bracket may be movable in the vertical direction depending on concave and convex portions of the light guide plate, and be disposed in a center portion about which the machining support unit is movable in the transverse direction.

Each of the machining support units may include a machining bracket disposed under the drive support, in which the machining bracket has a machining space located under the adjusting bracket, a lower portion of the machining space being open inwards, and shaft holes formed in opposite portions of the machining space in the machining direction of the light guide plate; and a machining hinge protrusion protruding from an upper central portion of the machining bracket, in which the machining hinge protrusion has a hinge hole into which the hinge shaft is fitted in the machining direction of the light guide plate, such that the machining bracket is hinged to the adjusting bracket. The machining bracket may be hinged to the adjusting bracket, with the machining unit intended to engrave the dots in the light guide plate being rotatably supported thereon, such that the machining bracket is movable in the transverse direction of the light guide plate.

The adjusting bracket may have adjusting holes formed in the opposite peripheries thereof in the transverse direction of the light guide plate. Each of the adjustment units further may include adjusting covers placed in opposite upper portions of the adjusting bracket, respectively, in which the adjusting covers open and close upper portions of the adjusting holes, respectively; adjusting elastic members disposed inside the adjusting bracket, in which each of the adjusting elastic members creates elastic force inside a respective one of the adjusting holes; and adjusting press members disposed in opposite lower portions of the adjusting bracket, respectively, in which a respective upper surface of the adjusting press members is elastically supported by a respective one of the adjusting elastic members, with a respective upper portion of the adjusting press members being restrained to and supported by a respective lower portion of the adjusting holes so as not to be released from the adjusting hole, and a respective lower portion of the adjusting press members is in contact with a respective upper surface of the machining support units. When the machining support unit hinged to the adjustment unit pivots about the hinge shaft, the adjusting press members, which are elastically supported by the adjusting elastic member and are in contact with the opposite upper portions of the machining support unit in the transverse direction, may become movable under pressing force of the adjusting elastic member and then return to original positions.

Each of the machining units may include a rotary shaft rotatably disposed inside the machining bracket, in which the rotary shaft is rotatably fitted into the shaft holes, and has a groove-type rotary key recess in an outer circumference thereof; a machining rotary member disposed inside the machining bracket, in which the machining rotary member has a hollow portion into which the rotary shaft is fitted, such that the machining rotary member rotates together with the rotary shaft, and a machining key recess in an inner surface thereof, the machining key recess formed in a position that opposes the rotary key recess; a coupling key disposed between the rotary shaft and the machining rotary member, in which the coupling key is fitted into the rotary key recess and the machining key recess, such that the rotary shaft and the machining rotary shaft rotate together; and teeth protruding from an outer surface of the machining rotary member, in which the teeth are blade-shaped in order to engrave the dots in the light guide plate. The teeth may be supported by the machining bracket, which is transported in the vertical and transverse directions, and be transported in the vertical and transverse directions following the operation of the drive unit. When the teeth reach a position that is in contact with a surface of the light guide plate that is intended to be machined, the teeth may engrave the dots in the LPG by maintaining contact with the light guide plate while the LPG is being carried in the machining direction on the machining table.

The teeth protruding from the outer surface of the machining rotary member may be spaced apart from each other at predetermined intervals by which the dots are engraved, and tooth recesses are radially formed depending on sizes of gaps that are shaped as blank regions, such that the gaps are formed by portions that are not engraved when the dots are being formed. Consequently, the teeth having the tooth recesses may form the gaps while engraving the dots in the light guide plate, and the gaps are formed depending on sizes and radial intervals of the tooth recesses.

The teeth protruding from the outer circumference of the machining rotary member may have sharp-pointed dot-forming portions. The dot-forming portions may be formed at distal ends of the teeth and are radially spaced from each other at predetermined intervals in order to engrave point-like dots in the light guide plate. Consequently, the teeth having the dot-forming portions may form the point-like dots while engraving the light guide plate.

According to embodiments of the invention, there is provided a plurality of machining units, which are spaced apart from each other at predetermined intervals and which engrave a dot pattern in the thin light guide plate through rotation in order to minimize machining pressure to the thin light guide plate, which refracts light that is incident from the light source. The machining units machine the light guide plate while being transported depending on the intervals of the dot pattern in order to minimize the machining pressure to the thin light guide plate, thereby decreasing defects due to the deformation in the machining.

In addition, after being placed in positions where the machining pressure to the thin light guide plate is minimized, the machining units are transported in the vertical and transverse directions to machine the thin light guide plate while the table on which the thin light guide plate is seated is being carried in the direction in which the thin light guide plate is intended to be machined This consequently minimizes the influence of the machining pressure during the machining of the thin light guide plate to prevent the deformation in the machining, thereby decreasing the defect ratio.

Furthermore, the machining units are configured to machine the engraved dot pattern while moving in the vertical direction under elasticity and pivoting in the transverse direction depending on concave and convex portions. Consequently, the machining units stay perpendicular to the light guide plate even in the concave and convex portions. This, as a result, can realize precise machining depths, thereby providing the effect of improving the quality of the light guide plate.

Moreover, in the rotating machining units, the tooth recesses are provided between the teeth depending on predetermined intervals of gaps such that the engraved dot pattern has gaps that are spaced apart from each other at the predetermined intervals. This, consequently, provides the effect of increasing generality.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing the state in which an apparatus having a negative dot pattern used in patterning a thin light guide plate according to an embodiment of the present invention is machining the light guide plate;

FIG. 2 is a perspective view showing major parts of the apparatus having a negative dot pattern used in machining a thin light guide plate shown in FIG. 1;

FIG. 3 is a cross-sectional view showing major parts of the apparatus having a negative dot pattern used in machining a thin light guide plate shown in FIG. 1;

FIG. 4 is a cross-sectional view showing some portions of the adjusting unit as a major part of the apparatus having a negative dot pattern used in machining a thin light guide plate shown in FIG. 1;

FIG. 5 is an exploded perspective view showing a machining support unit and a machining unit as major parts of the apparatus having a negative dot pattern used in machining a thin light guide plate shown in FIG. 1;

FIG. 6 is a view showing the state in which the apparatus having a negative dot pattern used in machining a thin light guide plate shown in FIG. 1 is pivoted depending on the concave and convex portions on the surface of the light guide plate;

FIG. 7 is a view showing a light guide plate in which a dot pattern is engraved using the apparatus having a negative dot pattern used in machining a thin light guide plate shown in FIG. 1;

FIG. 8 is an exploded perspective view showing another machining unit of the apparatus having a negative dot pattern used in machining a thin light guide plate shown in FIG. 8;

FIG. 9 is a view showing a light guide plate in which a dot pattern is engraved using the apparatus having a negative dot pattern used in machining a thin light guide plate shown in FIG. 8; and

FIG. 10 is a reference view showing the state in which various dot patterns are engraved using the apparatus having a negative dot pattern used in machining a thin light guide plate shown in FIG. 1.

### DETAILED DESCRIPTION OF THE INVENTION

Reference will now be made in greater detail to preferred embodiments of the present invention, examples of which are illustrated in the accompanying drawings, such that a person having ordinary skill in the art can easily make the present invention. However, the present invention is not limited to the following embodiments, but can be implemented using a variety of different forms. The same reference numerals will be used throughout the drawings to refer to the same or like parts.

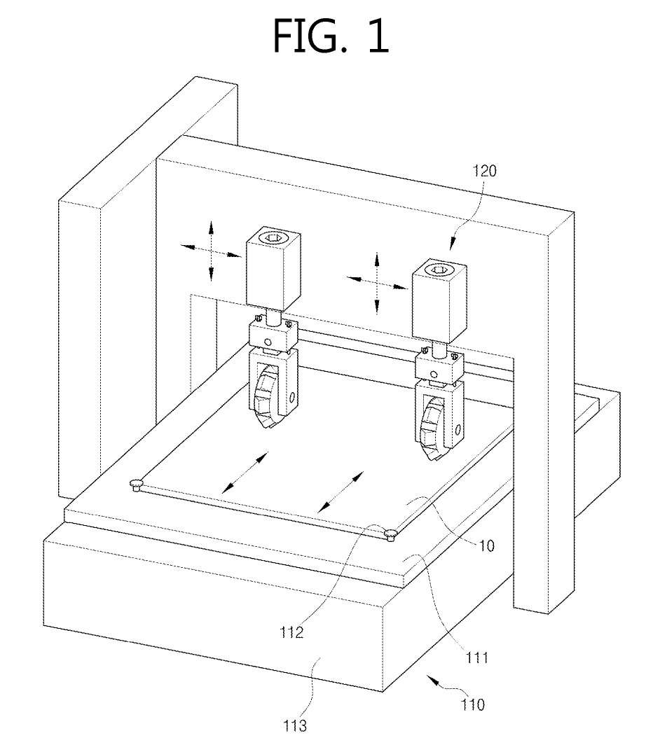

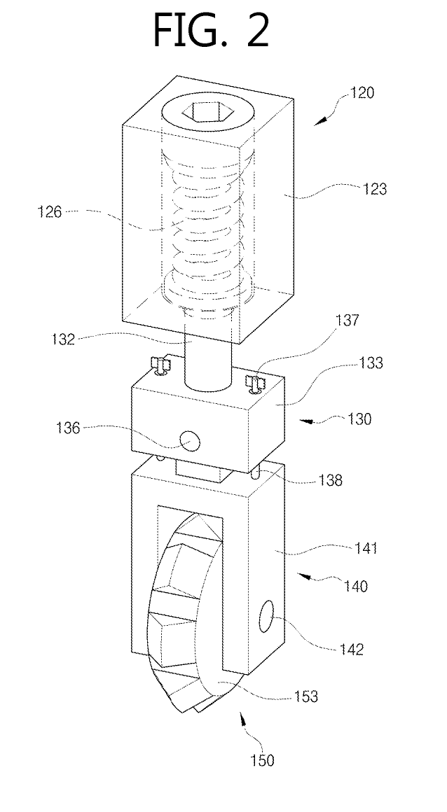

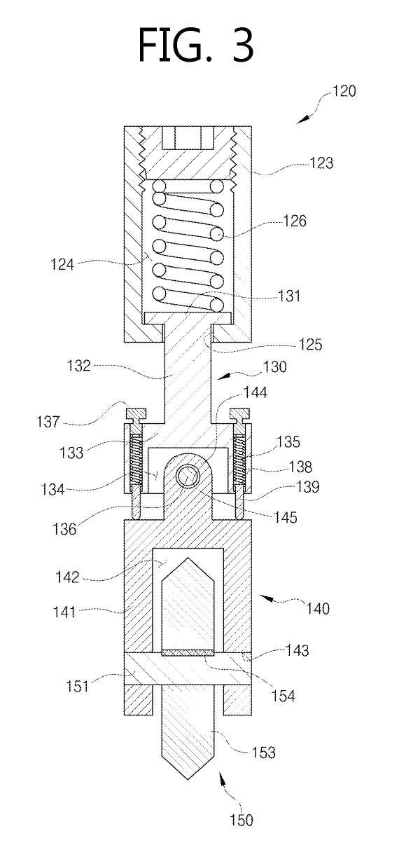

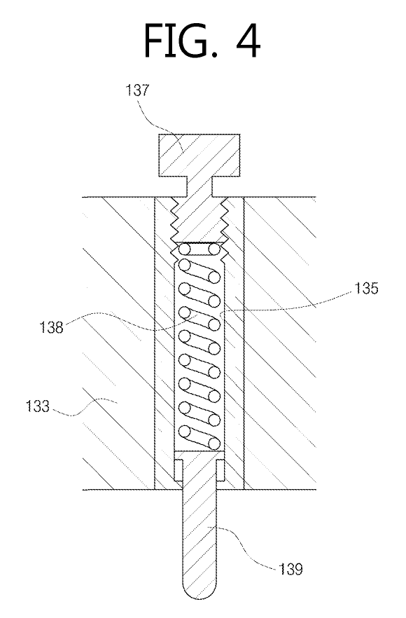

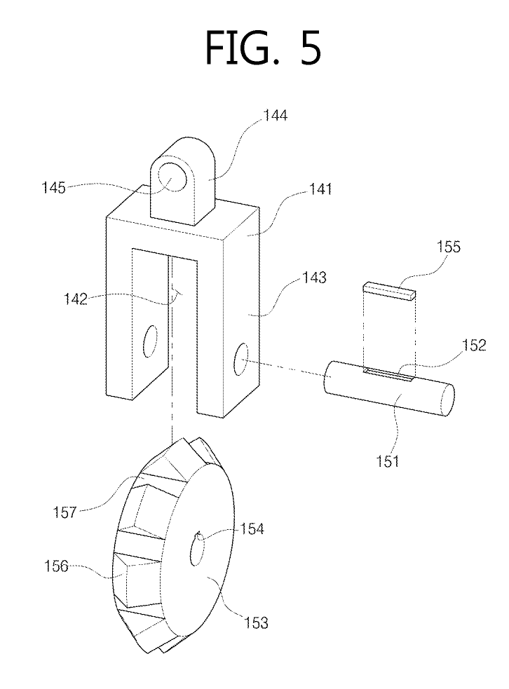

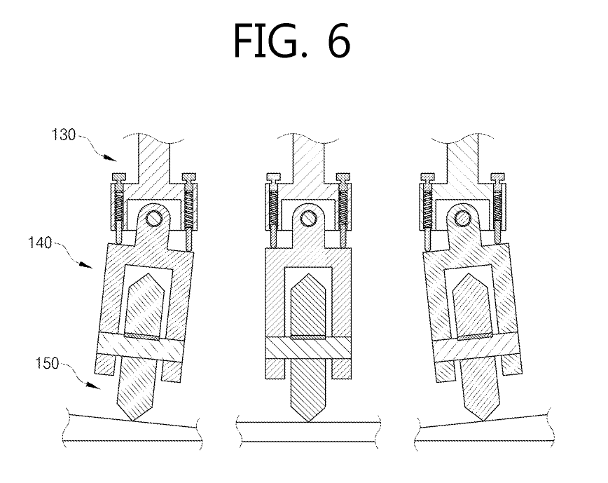

FIG. 1 is a perspective view showing the state in which an apparatus having a negative dot pattern used in patterning a thin light guide plate according to an embodiment of the present invention is machining the light guide plate, FIG. 2 is a perspective view showing parts of the apparatus having a negative dot pattern used in machining a thin light guide plate shown in FIG. 1, FIG. 3 is a cross-sectional view showing parts of the apparatus having a negative dot pattern used in machining a thin light guide plate shown in FIG. 1, FIG. 4 is a cross-sectional view showing some portions of the adjusting unit as a part of the apparatus having a negative dot pattern used in machining a thin light guide plate shown in FIG. 1, FIG. 5 is an exploded perspective view showing a machining support unit and a machining unit as major parts of the apparatus having a negative dot pattern used in machining a thin light guide plate shown in FIG. 1, and FIG. 6 is a view showing the state in which the apparatus having a negative dot pattern used in machining a thin light guide plate shown in FIG. 1 is pivoted depending on the concave and convex portions in the surface of the light guide plate.

Referring to FIG. 1 to FIG. 6, the apparatus (hereinafter, referred to as “dot pattern-engraving apparatus”) having a negative dot pattern used in machining a thin light guide plate of this embodiment serves to engrave a concave dot pattern, which refracts incident light, in an light guide plate 10, and includes a machining table unit 110, a drive unit 120, an adjustment unit 130, a machining support unit 140, and a machining unit 150. The machining table unit 110 carries the light guide plate 10 in the direction in which machining is performed (hereinafter, referred to as “machining direction.”

The machining table unit 110 includes a machining table 111, which is movable in the machining direction with the light guide plate 10 seated thereon, absorption fixing devices 112, and a machining carriage 113.

The machining table 111 is disposed under the light guide plate 10, with the upper portion thereof supporting the light guide plate 10 when dots 11 are being engraved in the light guide plate 10. The machining table 111 has the shape of a plate on which the light guide plate 10 is seated, and is disposed such that it is movable together with the light guide plate 10 in the machining direction in response to the operation of the machining carriage 113.

The absorption fixing devices 112 are placed inside the machining table 111, and are disposed to absorb a move or shock of the light guide plate 10. The absorption fixing devices 112 are positioned inside the machining table 111, and are disposed to securely fix the thin light guide plate 10 while minimizing any damage to the thin light guide plate 10. Here, the absorption fixing devices 112 may be implemented using any known devices such as a device using pneumatic pressure, and thus detailed descriptions thereof will be omitted.

The machining carriage 113 is placed under the machining table 111, and is disposed such that it carries the machining table 111 in the machining direction. The machining carriage 113 is fixed by the absorption fixing devices 112, and provides driving force that moves itself together with the machining table 111. Here, the machining carriage 113 may be implemented using any means that carries the machining table 111 in the machining direction, detailed descriptions of which will be omitted.

That is, the light guide plate 10 is seated on top of the machining table 111, is fixed by the absorption fixing devices 112, and is moved in the machining direction following the operation of the machining carriage 113 while being machined by the machining unit 150.

The drive unit 120 includes a drive device, which moves itself in vertical and transverse directions, a drive body, a drive support 123, and a supporting elastic member 126.

The drive device provides power to move in the transverse direction in which the dots 11 are arrayed in the upper surface of the light guide plate 10, which is machined, and the vertical direction. In the position above the light guide plate 10 that is being carried in the machining direction following the operation of the machining table unit 110, the drive device provides power to drive the machining unit 150 in the transverse and vertical directions so that the machining unit 150 is transported to a machining position. That is, in order to separately machine the dots 11 to minimize a deformation in the machining of the dots 11, which are arrayed in the transverse direction in the light guide plate 10 that is being transported in the machining direction, the machining unit 150 is transported in the vertical and transverse directions following the operation of the drive device so that it is transported to the machining position.

The drive body is placed on one side of the drive device, is positioned above the light guide plate 10 such that it moves in the transverse direction, and has the shape of a plate that is transported in the vertical and transverse directions depending on the machining position following the operation of the drive device.

A plurality of the drive supports 123 are placed on one side of the drive body that is movable, and are spaced apart from each other at predetermined intervals. The drive support 123 has a support space therein, and the upper portion of the support space 124 is closed, and the lower portion of the support space 124 in which the adjustment unit 130 is positioned is opened. The adjustment unit 130, the machining support unit 140, and the machining unit 150 are disposed under the drive support 123, and a plurality of such units are spaced apart from each other at predetermined intervals that are set to minimize a deformation in machining, if any, depending on the material and size of the thin light guide plate and the interval of the engraved dots 11, which are carried in the vertical and transverse directions. That is, one or more drive supports 123 are provided, and the drive supports 123 are spaced apart from each other depending on the size of the light guide plate 10, particularly, at the interval that is set to minimize a deformation when the light guide plate 10 is being machined in order to engrave the dots 11 while minimizing the deformation in the machining

The lower portion of the support space 124 is open, thereby forming a support hole 125, which exposes the support space 124. An object can be received such that it is positioned in the direction toward the support hole 125, and move up and down inside the support space 124.

The supporting elastic member 126 is placed inside the drive support 123, and is disposed to provide elastic force in the support space 124. The supporting elastic member 126 is disposed inside the support space 124 such that elastic force is applied downwards to the adjustment unit 130, which is disposed inside the support space 124. Specifically, the drive supports 123 are disposed per unit in a plurality of separate positions of the drive body, and the adjustment unit 130 is disposed in the support space 124 such that it is elastically supported by the supporting elastic member 126. Consequently, the adjustment unit 130 can be adjusted in height as it returns to its original position after being transported in the vertical direction inside the drive support 123. Although the supporting elastic member 126 is represented as a spring that provides elasticity herein, this is for the sake of brevity. The supporting elastic member 126 may be implemented using any device that provides elasticity, such as a damper, an air cylinder, a servo motor, and a hydraulic cylinder.

The adjustment unit 130 includes an adjusting head 131, which is elastically supported inside the drive support 123, an adjusting shaft 132, an adjusting bracket 133, a hinge shaft 136, adjusting covers 137, adjusting elastic members 138, and adjusting press members 139.

The adjusting head 131 is placed inside the drive support 123, and is disposed such that the upper portion of the adjusting head 131 is elastically supported by the supporting elastic member 126 and the lower portion of the adjusting head 131 is restrained to the support space 124 so that it can move in the vertical direction without being released from the support space 124.

The adjusting shaft 132 protrudes from the lower portion of the adjusting head 131, extending downwards through the support hole 125 from inside the support space 124. The adjusting shaft 132 connects the adjusting head 131 to the adjusting bracket 133 such that the adjusting bracket 133 can move along with the adjusting head 131, which is movable in the vertical direction.

The adjusting bracket 133 is placed under the drive support 123. The upper portion of the adjusting bracket 133 is fixed to the adjusting shaft 132 such that it can move along with the adjusting head 131. The adjusting bracket 133 has therein an adjusting space 134, the lower portion of which is open. The adjusting bracket 133 is connected to the adjusting shaft 132, and is disposed such that it can move up and down together with the adjusting head 131. Even after being pushed up, the adjusting head 131 is forced downwards by the elastic force of the supporting elastic member 126, thereby returning to the original position. The lower portion of the adjusting space 134 is open such that a portion of the machining support unit 140 is disposed therein.

The adjusting holes 135 are formed in the opposite peripheries of the adjusting bracket 133 in the transverse direction of the light guide plate 10. The adjusting holes 135 extend through the adjusting bracket 133 such that the machining support unit 140 is positioned under the adjusting holes 135.

The hinge shaft 136 is placed inside the adjusting bracket 133, in a position of the support space 134 that extends along the machining direction of the light guide plate 10, and is hinged to the machining support unit 140, such that the machining support unit 140 can pivot in the transverse direction. The hinge shaft 136 is disposed in the position of the support space 134 that extends along the machining direction of the light guide plate 10, and is hinged to the machining support unit 140 inside the support space 134, such that the machining support unit 140 can pivot in the transverse direction of the light guide plate 10.

Specifically, the adjusting bracket 133 is connected via the adjusting shaft 132 to the adjusting head 131, which is elastically connected to the drive support 123 such that it is vertically movable inside the drive support 123. Here, a plurality of drive supports 123 are provided per unit. The hinge shaft 136 is hinged inside the adjusting bracket 133 such that the adjustment unit 130 is movable in the transverse direction. Consequently, the adjusting bracket 133 can be configured such that it is movable up and down depending on the concave and convex portions of the light guide plate 10, and be disposed in the center about which the machining support unit 140 is movable in the transverse direction.

The adjusting covers 137 are placed in the opposite upper portions of the adjusting bracket 133, respectively, and are disposed to open and close the upper portions of the adjusting holes 135. Since the adjusting covers 137 are disposed to open and close the upper portions of the adjusting holes 135, they are disposed to close the upper portions when the adjusting elastic members 138 are fitted in the adjusting holes 135 so that the adjusting elastic members 138 create downward elastic force.

Each of the adjusting elastic members 138 is disposed inside the adjusting bracket 133 such that it creates the elastic force inside a respective adjusting hole 135.

The adjusting press members 139 are placed in the opposite lower portions of the adjusting bracket 133, respectively. The upper surface of the adjusting press member 139 is elastically supported by the adjusting elastic member 138, with the upper portion of the adjusting press member 139 being restrained to and supported by the lower portion of the adjusting hole 135 so that it is not released from the adjusting hole 135, and the lower portion of the adjusting press member 139 is in contact with the upper surface of the machining support unit 140. When the machining support unit 140, which is hinged to the adjustment unit 130, pivots about the hinge shaft 136, the adjusting press members 139, which are elastically supported by the adjusting elastic member 138 and are in contact with the opposite upper portions of the machining support unit 140 in the transverse direction, can be moved under the pressing force of the adjusting elastic member 138 and then return to their original positions. That is, the adjusting press member 139, which is elastically supported by the adjusting elastic members 138, is disposed on an either portion of the machining support unit 140, which is hinged to the hinge shaft 136 such that it pivots about the hinge shaft 136. Consequently, the adjusting press member 139 is moved depending on the concave and convex portions of the light guide plate 10 and then returns to its original position.

The machining support unit 140 includes a machining bracket 141 and a machining hinge protrusion 144, which are placed under the adjusting bracket 133. The machining bracket 141 is disposed under the drive support 123, and has a machining space 142, which is located under the adjusting bracket 133. The lower portion of the machining space 142 is open inwards. Shaft holes 143 are formed in opposite portions of the machining space 142 in the direction in which the light guide plate 10 is machined. The machining bracket 141 is hinged to the adjusting head 131, which is elastically supported by the supporting elastic member 126 such that it can move up and down, in the transverse direction of the light guide plate 10. The machining space 142 is open in the lower end thereof and is configured such that the machining unit 150 is rotatably fitted to the shaft holes 143.

The machining hinge protrusion 144 protrudes from the upper central portion of the machining bracket 141, and has the hinge hole 145 into which the hinge shaft 136 is fitted in the direction in which the light guide plate 10 is machined, such that the machining bracket 141 is hinged to the adjusting bracket 133.

The machining bracket 141 is hinged to the adjusting bracket 133, with the machining unit 150, which is intended to engrave the dots 11 in the light guide plate 10, being rotatably supported thereon, such that the machining bracket 141 is movable in the transverse direction of the light guide plate 10.

The machining unit 150 includes a rotary shaft 151, which is rotatably placed inside the machining bracket 141, a machining rotary member 153, a coupling key 155, and teeth 156. The rotary shaft 151 is rotatably placed inside the machining bracket 141, and is rotatably fitted into the shaft holes 143. The rotary shaft 151 is rotatably fitted into the machining bracket 141, which is movable in the vertical direction and in the transverse direction of the light guide plate 10 when the dots 11 are being engraved in the light guide plate 10. A groove-type rotary key recess 152 is formed in the outer circumference of the rotary shaft 151. The rotary key recess 152 is configured such that the coupling key 155, which enables the rotary shaft 151 to rotate together with the machining rotary member 153, is fitted into the rotary key recess 152.

The machining rotary member 153 is placed inside the machining bracket 141, and has a hollow portion into which the rotary shaft 151 is fitted, such that it may rotate together with the rotary shaft 151. The machining rotary member 153 is disposed to rotate together with the rotary shaft 151, which is fitted thereinto, thereby machining the light guide plate 10. A machining key recess 154 is formed in the inner surface of the machining rotary member 153, in the position that opposes the rotary key recess 152. The machining key recess 154 is configured such that the coupling key 155 can be fitted into the machining key recess 154 so that the machining rotary member 153 can rotate together with the rotary shaft 151.

The coupling key 155 is placed between the rotary shaft 151 and the machining rotary member 153, and is fitted into the rotary key recess 152 and the machining key recess 154, such that the rotary shaft 151 and the machining rotary shaft 151 can rotate together.

The teeth 156 protrude from the outer surface of the machining rotary member 153, and tooth recesses 157 are radially formed depending on the size of gaps 12 such that the gaps 12 are formed by the portions that are not engraved when the dots 11 are being formed. The teeth 156 are disposed such that they are movable in the vertical and transverse directions of the drive support 123, and radially protrude such that the tooth recesses 157 are formed on the outer surface of the machining rotary member 153. Here, a plurality of the drive supports 123 are disposed above the light guide plate 10, and are spaced apart from each other in the transverse direction at predetermined intervals in which the machining deformation is minimized.

In addition, the tooth recesses 157 are formed to alternate with the teeth 156 such that gaps, i.e., blank regions, are formed between the linear dots 11 when the dots 11 are engraved. The tooth recesses 157 are provided at a predetermined size such that the interval of the gaps 12 between the engraved dots 11 may be adjusted in order to improve the brightness and uniformity of refracting light depending on the shape, type, and interval of light emitting materials.

That is, the teeth 156 are rotatably supported on the machining bracket 141, which moves in the vertical and transverse directions. When the teeth 156 are moved in the machining direction by the operation of the drive device while keeping in contact with the machining surface of the light guide plate 10, they can engrave the dots 11 in positions corresponding to the tooth 156 such that the dots 11 alternate with the gaps 12.

In the light guide plate 10 that is machined by the dot pattern-engraving apparatus as described above, the gaps 12 are formed depending on the shape, type, and interval of the light emitting materials 1, as regions that are not engraved in line with the dots 11, in order to improve refracting efficiency. The gaps 12 are the regions that are not machined, and are formed at different intervals depending on the shape, type, and interval of the light emitting materials 1 in line with the dots 11.

In particular, in the case in which a plurality of light emitting materials 1 is disposed, with its size greatly reduced, such as in Light-Emitting Diodes (LEDs) or Organic Light-Emitting Diodes (OLEDs), hot spots occur since light beams overlap each other between the light emitting materials 1 or light distribution is not uniform. In the case of a three-dimensional image, light beams are radiated alternately to the right and left in order to create an optical illusion, unlike in a two-dimensional image. Then, the light beams may overlap each other or light distribution may not become uniform, thereby creating hot spots.

The hot spots occur when light beams overlap each other or light distribution is not uniform, and can be minimized using the light guide plate 10 in which light refractivity indices are different in the overlapping portions or the non-uniform positions.

In the engraved dot pattern of an embodiment of the present invention, the gaps 12 are formed between the engraved dots 11, such that light that is not refracted passes through the positions of the gaps 12, and the engraved dots 11 and the gaps 12, which are arrayed in plurality in the transverse direction, are formed in different positions. Consequently, it is possible to machine the light guide plate 10 that can minimize the hot spots by improving the brightness and uniformity of refracting light.

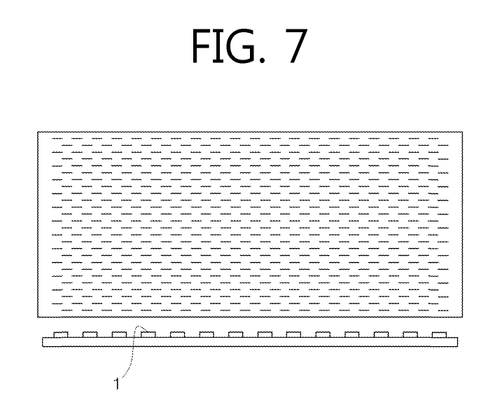

In addition, referring to FIG. 7, the light guide plate can be machined with the teeth 156 with the tooth recesses 157 by operating the drive unit 120 such that the gaps 12 intersect each other. This can consequently isolate the gaps 12, i.e., blank regions, without being connected to each other, thereby preventing the moiré phenomenon.

Since the tooth recesses 157 and the teeth 156 are configured to intersect each other when arrayed in the transverse direction of the light guide plate 10, a number of engraved dots 11 and gaps 12 are formed to intersect each other in the transverse direction when the light guide plate 10 is being machined

When dots are engraved by traditional methods, blank regions similar to gaps may be unintentionally formed due to non-uniform refractive indices or machining defects. The moiré phenomenon having the form of waves may then occur due to the different refractive indices, thereby degrading image quality. Even though the moiré phenomenon may occur when the engraving is performed so that the gaps are connected to each other without intersecting each other, the dot pattern-engraving apparatus having a negative pattern of the present invention can form the gaps 12 in mutually intersecting positions in machining the light guide plate, so that wave-like dispersion is blocked by the engraved dots 11, thereby preventing the moiré phenomenon and improving image quality.

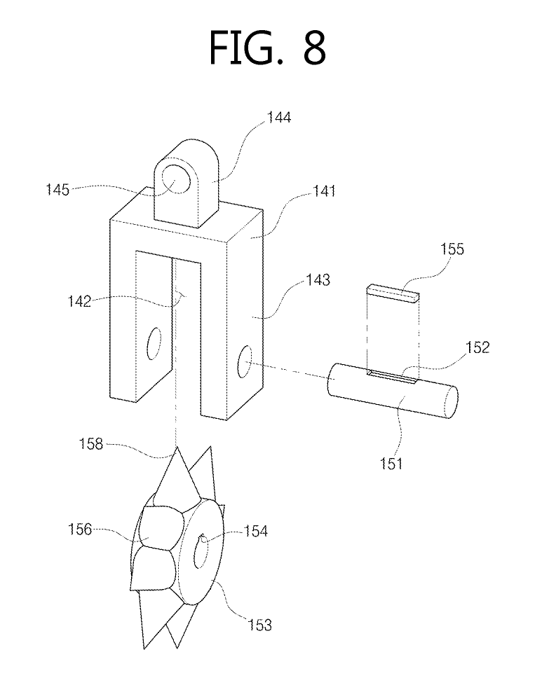

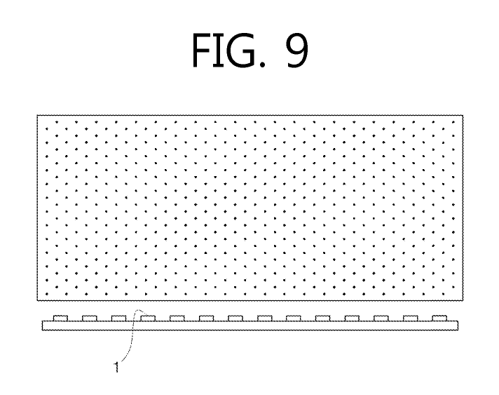

Referring to FIG. 8 and FIG. 9, the teeth 156 that protrude from the outer circumference of the machining rotary member 153 have sharp-pointed dot-forming portions 158, which are formed at the distal ends of the teeth 156 and are radially spaced from each other at predetermined intervals in order to engrave point-like dots 11 in the light guide plate 10.

The teeth 156 having the dot-forming portions 158 can engrave the point-like dots 11 while rotating on the light guide plate 10.

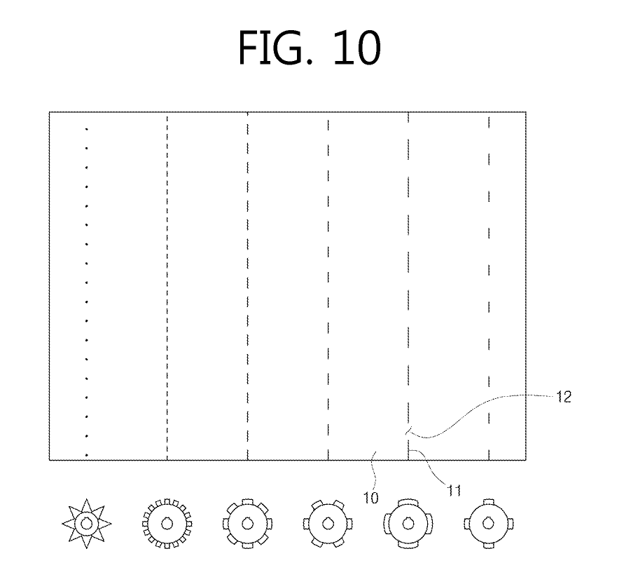

Referring to FIG. 10, the dots 11 and the point-like dots 11 can be engraved at the intervals of the gaps 12 along lines depending on the shapes of the teeth 156, thereby increasing machining efficiency.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for machining a light guide plate, the apparatus comprising:
a machining table unit on which the light guide plate is to be placed, the machining table unit being movable in a machining direction when the light guide plate is being machined in a state in which the light guide plate is seated on the machining table unit;
a drive unit disposed over the machining table unit, the drive unit comprising a drive device for providing power to move in a transverse direction in which dot pattern is to be formed in an upper surface of the light guide plate and in a vertical direction and a plurality of drive supports spaced apart from each other at predetermined intervals in the transverse direction of the light guide plate, the drive supports being movable in the transverse direction and the vertical direction in response to an operation of the drive device;
a plurality of adjustment units disposed over the light guide plate, wherein each of the adjustment units is supported on a respective one of the drive supports such that the respective adjustment unit is movable in the vertical direction;
a plurality of machining support units disposed over the light guide plate, wherein each of the machining support units is hinged to a respective lower portion of the adjustment units such that the each machining support unit pivots in the transverse direction of the light guide plate; and
a plurality of machining units disposed over the light guide plate, wherein each of the machining units is rotatably disposed on a respective lower portion of the drive supports, and has teeth on an outer circumference thereof, wherein the teeth are configured to machine the light guide plate, each of the machining unit capable of engraving dots while the light guide plate is being carried in the machining direction.

2. The apparatus of claim 1, wherein the machining table unit comprises:
a machining table disposed under the light guide plate, wherein an upper portion of the machining table supports the light guide plate when the dots are engraved in the light guide plate;
an absorption fixing device disposed inside the machining table, wherein the absorption fixing device fixes the machining table and the light guide plate, thereby preventing the light guide plate from moving, when the light guide plate is being machined; and
a machining carriage disposed under the machining table, wherein the machining carriage transports the machining table to which the light guide plate is fixed via absorption.

3. The apparatus of claim 1, wherein the drive units comprises:
a drive body disposed on one side of the drive device, wherein the drive body is positioned above the light guide plate such that the drive body moves in the transverse direction, and has a shape of a plate that is transported in the vertical and transverse directions depending on the machining position following the operation of the drive device;
the plurality of drive supports disposed on one side of the drive body that is movable, wherein each of the plurality of drive supports has a closed upper portion, an inner support space, in which the adjustment unit is positioned, and a support hole perforated to open a portion of the support space, and the plurality of the drive supports are spaced apart from each other at the predetermined intervals that are set to restrict a deformation in machining depending on depths to which the engraved dots are machined in the light guide plate, and independently machine the engraved dots; and
a supporting elastic member disposed inside the drive support to provide elastic force inside the support space, the adjustment unit disposed in the support space to be supported by the supporting elastic member so that height adjustment is performed when the adjustment unit returns to an original position after being transported in the vertical direction inside the drive support.

4. The apparatus of claim 3, wherein each of the adjustment units comprises:
an adjusting head disposed inside the drive support, wherein an upper portion of the adjusting head is elastically supported by the supporting elastic member and a lower portion of the adjusting head is restrained to the support space so that the adjusting head is movable in the vertical direction without being released from the support space;
an adjusting shaft protruding from the lower portion of the adjusting head, wherein the adjusting shaft extends downwards through the support hole from inside the support space;
an adjusting bracket disposed under the drive support, wherein an upper portion of the adjusting bracket is fixed to the adjusting shaft such that the adjusting bracket is movable along with the adjusting head, and wherein the adjusting bracket has therein an adjusting space, a lower portion of the adjusting space being open; and
a hinge shaft disposed inside the adjusting bracket, wherein the hinge shaft is disposed in a position of the support space that extends along the machining direction of the light guide plate and is hinged to the machining support unit, such that the machining support unit is allowed to pivot in the transverse direction;
wherein the adjusting bracket is connected via the adjusting shaft to the adjusting head, which is elastically connected to the drive support such that the adjusting head is vertically movable inside the drive support, and the hinge shaft is hinged inside the adjusting bracket such that the adjustment unit is movable in the transverse direction, whereby the adjusting bracket is movable in the vertical direction depending on concave and convex portions of the light guide plate, and is disposed in a center portion about which the machining support unit is movable in the transverse direction.

5. The apparatus of claim 4, wherein each of the machining support units comprises:
a machining bracket disposed under the drive support and hinged to the adjusting bracket, wherein the machining bracket has a machining space located under the adjusting bracket, a lower portion of the machining space being open, and shaft holes formed in portions of the machining space in the machining direction of the light guide plate, the machining unit rotatably supported on the machining bracket, the machining bracket being movable in the transverse direction of the light guide plate; and
a machining hinge protrusion protruding from an upper portion of the machining bracket, wherein the machining hinge protrusion has a hinge hole into which the hinge shaft is fitted in the machining direction of the light guide plate, such that the machining bracket is hinged to the adjusting bracket.

6. The apparatus of claim 5, wherein the adjusting bracket has adjusting holes vertically formed in the peripheries of the adjusting bracket, the adjusting holes arranged in the transverse direction of the light guide plate; and
each of the plurality of adjustment units further comprises:
adjusting covers placed in upper portions of the adjusting bracket, respectively, to open and close upper portions of the adjusting holes, respectively;
adjusting elastic members disposed in the adjusting holes to create elastic force inside a respective one of the adjusting holes; and
adjusting press members disposed in lower portions of the adjusting bracket, respectively, wherein a respective upper surface of the adjusting press members is elastically supported by a respective one of the adjusting elastic members, with a respective upper portion of the adjusting press members being restrained to and supported by a respective lower portion of the adjusting holes so as not to be released from the adjusting hole, and a respective lower portion of the adjusting press members is in contact with a respective upper surface of the machining support units, wherein, when the machining support unit hinged to the adjustment unit pivots about the hinge shaft, the adjusting press members, which are elastically supported by the adjusting elastic member and are in contact with the upper portions of the machining support unit in the transverse direction, become movable under pressing force of the adjusting elastic member and then return to original positions.

7. The apparatus of claim 5, wherein each of the machining units comprises:
a rotary shaft rotatably disposed inside the machining bracket, wherein the rotary shaft is rotatably fitted into the shaft holes, and has a groove-type rotary key recess in an outer circumference thereof;
a machining rotary member disposed inside the machining bracket, wherein the machining rotary member has a hollow portion into which the rotary shaft is fitted, such that the machining rotary member rotates together with the rotary shaft, and a machining key recess in an inner surface thereof, the machining key recess formed in a position that opposes the rotary key recess;
a coupling key disposed between the rotary shaft and the machining rotary member, wherein the coupling key is fitted into the rotary key recess and the machining key recess, such that the rotary shaft and the machining rotary shaft rotate together; and
teeth protruding from an outer surface of the machining rotary member, wherein the teeth are blade-shaped in order to engrave the dots in the light guide plate, the teeth rotatably supported by the machining bracket, the teeth being transported in the vertical and transverse directions following the operation of the drive unit, wherein, when the teeth reach a position that is in contact with a surface of the light guide plate that is to be machined, the teeth engrave the dots in the light guide plate by maintaining contact with the light guide plate while the light guide plate is being carried in the machining direction on the machining table.

8. The apparatus of claim 7, wherein the teeth protruding from the outer surface of the machining rotary member are spaced apart from each other at predetermined intervals to engrave the dots, and tooth recesses are radially formed depending on sizes of gaps that are shaped as blank regions, such that the gaps are formed by portions that are not engraved when the dots are being formed, whereby the teeth with the tooth recesses form the gaps while engraving the dots in the light guide plate, and the gaps are formed depending on sizes and radial intervals of the tooth recesses.

9. The apparatus of claim 7, wherein the teeth protruding from the outer circumference of the machining rotary member have sharp-pointed dot-forming portions formed at distal ends of the teeth and radially spaced from each other at predetermined intervals in order to engrave point-like dots in the light guide plate, whereby the teeth having the dot-forming portions form the point-like dots while engraving the light guide plate.
